(19) United States
(12) Patent Application Publication
(10) Pub. No.: US 2024/0163568 A1
(43) Pub. Date: May 16, 2024

(54) IMAGE CAPTURING APPARATUS THAT GENERATES IMAGES THAT CAN BE DEPTH-COMBINED, METHOD OF CONTROLLING SAME, AND STORAGE MEDIUM

(71) Applicant: CANON KABUSHIKI KAISHA, Tokyo (JP)

(72) Inventor: Shinji HISAMOTO, Kanagawa (JP)

(21) Appl. No.: 18/505,360

(22) Filed: Nov. 9, 2023

(30) Foreign Application Priority Data
Nov. 14, 2022 (JP) 2022-181827

(51) Int. Cl. H04N 23/741; G06T 7/50; H04N 5/265; H04N 23/667

(52) U.S. Cl. CPC H04N 23/741; G06T 7/50; H04N 5/265; H04N 23/667; G06T 2207/10144; G06T 2207/10148; G06T 2207/10152; G06T 2207/20208; G06T 2207/20212; H04N 23/67

(57) ABSTRACT

An image capturing apparatus includes an image capturing unit configured to capture an image of an object. An evaluation area for determining exposure level differences applied when HDR image capturing is performed by the image capturing unit is set. Depth information in the evaluation area is acquired. Image capturing conditions are determined so as to make each of all objects in the evaluation area focused in at least one of a plurality of images captured by changing a depth of focus based on the depth information. The image capturing unit is controlled to perform the HDR image capturing according to the image capturing conditions. HDR images are generated by combining images obtained by performing HDR image capturing according to each image capturing condition. A depth combined image is generated from the plurality of combined HDR images.

### BACKGROUND

### Field

The present disclosure relates to an image capturing apparatus, a method of controlling the same, and a storage medium, and more particularly to a technique for capturing images different in in-focus position and combining the captured images.

### Description of the Related Art

When images of a plurality of objects that are largely separate from each other are captured or an image of an object that extends long in a depth direction is captured, by using an image capturing apparatus, such as a digital camera, there sometimes arises a case where only some of the objects or only part of one object can be focused, due to the insufficient depth of field. To solve this problem, Japanese Laid-Open Patent Publication (Kokai) No. 2015-216532 discloses a technique (hereinafter referred to as the “depth combining technique”) in which a plurality of images that are different in in-focus position are captured and only in-focus areas are extracted from the images to generate one combined image in which the whole captured image area is in focus (hereinafter referred to as the “depth combined image”).

By using the depth combining technique, for example, in scenery photography, it is possible to obtain an image in which not only the foreground, but also the background is in focus. Further, in still life photography, it is possible to obtain an image in which the whole main object is in focus.

Here, also in the depth combined image, it is desirable that the brightness of an object is appropriate. For example, Japanese Laid-Open Patent Publication (Kokai) No. 2022-77591 discloses a technique for setting an area of a main object and an area other than the main object for a plurality of images used for depth combination and correcting the gradation of each area.

However, in scenery photography in a scene in which sunny areas and shadow areas are mixed or still life photography in a scene where light is applied to a wristwatch or jewel placed on a dark table or a base, it is difficult to prevent generation of overexposure part and underexposure part in a captured image because of a large difference in brightness.

Further, in a case where a user intends to focus on the whole angle of view (image capturing range) as in a scenery image, it is desired to prevent generation of overexposure part and underexposure part in the whole angle of view. On the other hand, in a scene where a main object is desired to be focused as in a still life photography image, generation of overexposure part and underexposure part is sometimes allowed for areas other than the main object while it is desired to prevent generation of overexposure part and underexposure part on the main object. Thus, the dynamic range required for a captured image is different depending on a photographing scene.

### SUMMARY

The present disclosure provides an image capturing apparatus that is capable of generating a depth combined image having an appropriate dynamic range according to a photographing scene.

In a first aspect of the present disclosure, there is provided an image capturing apparatus including an image capturing unit configured to capture an image of an object, at least one processor, and a memory coupled to the at least one processor, the memory having instructions that, when executed by the processor, perform the operations as: a setting unit configured to set an evaluation area for determining exposure level differences applied when HDR image capturing is performed by the image capturing unit, an acquisition unit configured to acquire depth information in the evaluation area, a determination unit configured to determine image capturing conditions so as to make each of all objects in the evaluation area focused in at least one of a plurality of images captured by changing a depth of focus based on the depth information, a control unit configured to control the image capturing unit to perform the HDR image capturing according to the image capturing conditions, a combination unit configured to generate a plurality of HDR images by combining images each obtained by the HDR image capturing performed according to each image capturing condition, and a generation unit configured to generate a depth combined image from the plurality of HDR images generated by the combination unit.

In a second aspect of the present disclosure, there is provided a method of controlling an image capturing apparatus, including setting an evaluation area for determining exposure level differences applied when HDR image capturing is performed by an image capturing unit, acquiring depth information in the evaluation area, determining image capturing conditions so as to make each of all objects in the evaluation area focused in at least one of a plurality of images captured by changing a depth of focus based on the depth information, controlling the image capturing unit to perform the HDR image capturing according to the image capturing conditions, generating a plurality of HDR images by combining images each obtained by the HDR image capturing performed according to each image capturing condition, and generating a depth combined image from the plurality of generated HDR images.

According to the present disclosure, it is possible to provide an image capturing apparatus that is capable of generating a depth combined image having an appropriate dynamic range according to a photographing scene.

Further features of the present disclosure will become apparent from the following description of exemplary embodiments (with reference to the attached drawings).

### BRIEF DESCRIPTION OF THE DRAWINGS

FIG. 1 is a block diagram showing a schematic configuration of an image capturing apparatus according to embodiments.

FIG. 2 is a flowchart of a depth combined image generation process performed by the image capturing apparatus.

FIGS. 3A to 3D are diagrams useful in explaining two photographing scenes each having a large difference in brightness.

FIG. 4 is a flowchart of a photometry and HDR difference-setting process in the depth combined image generation process in FIG. 2.

FIGS. 5A and 5B are flowcharts of a depth combining process in the depth combined image generation process in FIG. 2.

### DESCRIPTION OF THE EMBODIMENTS

The present disclosure will now be described in detail below with reference to the accompanying drawings showing embodiments thereof.

Embodiments of the present disclosure will be described in detail below with reference to the accompanying drawings.

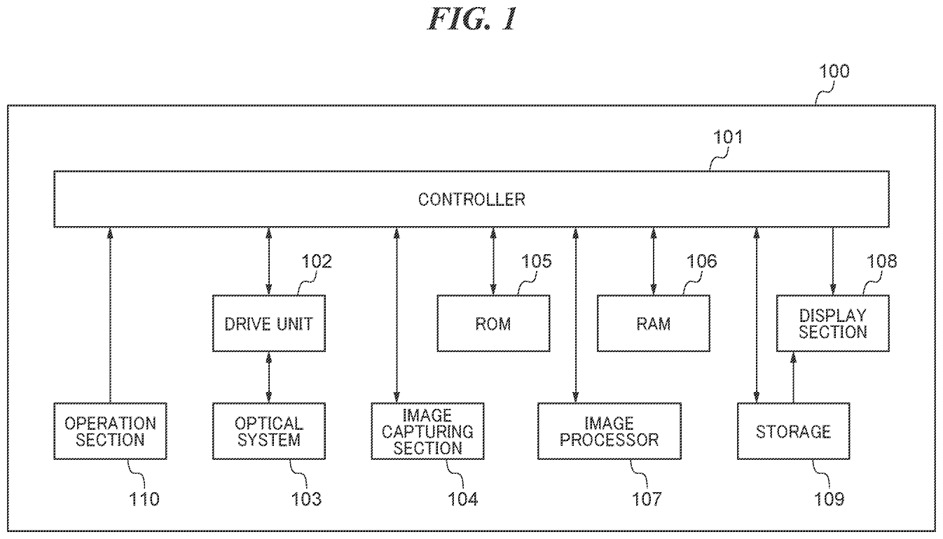

FIG. 1 is a block diagram showing a schematic configuration of an image capturing apparatus 100 according to a first embodiment. The image capturing apparatus 100 is, more specifically, a so-called digital camera, and is capable of capturing a still image, recording information on an in-focus position, and performing calculation of a contrast value and image combination. Further, the image capturing apparatus 100 is capable of performing processing for enlarging/reducing a captured image.

Note that the present disclosure can be applied not only to the digital camera, but also, for example, to an electronic device, such as a smartphone and a tablet PC, insofar as it is equipped with an image capturing function using an image sensor, such as a complementary metal-oxide-semiconductor (CMOS) sensor, and image processing functions including the image combination and the enlarging/reducing a captured image.

The image capturing apparatus 100 includes a controller 101, a drive unit 102, an optical system 103, an image capturing section 104, a read only memory (ROM) 105, a random access memory (RAM) 106, an image processor 107, a display section 108, a storage 109, and an operation section 110.

The controller 101 is a signal processor, such as a central processing unit (CPU) or a micro processing unit (MPU), and performs centralized control of the operations of the components of the image capturing apparatus 100 by loading programs stored in the ROM 105 into the RAM 106 and executing the loaded programs. For example, the controller 101 issues commands for starting and terminating image capturing to the image capturing section 104 and issues an image processing command to the image processor 107.

The ROM 105 stores the operation programs for the blocks forming the image capturing apparatus 100, parameters necessary for the operations of the blocks, and so forth. The RAM 106 has a work area for loading a program read out from the ROM 105 by the controller 101 and a storage area for temporarily storing, for example, image data output from the image capturing section 104 (image processor 107) and image data read out from the storage 109.

The operation section 110 is comprised of switches, buttons, and keys, to each of which a predetermined command is assigned, a touch panel which is superposed and arranged on the display section 108, and so forth, for receiving a user operation and notifying the controller 101 of each assigned command. The controller 101 performs processing corresponding to the command received from the operation section 110.

The optical system 103 is comprised of a zoom lens, a focus lens, a diaphragm, and so forth, and forms an image of an incident light from an object on an image sensor (not shown) of the image capturing section 104. It is possible to adjust an angle of view (image capturing range) by driving the zoom lens, perform a focusing operation (focus adjustment) by driving the focus lens, and adjust an amount of light transmitted through the optical system 103 by driving the diaphragm. The drive unit 102 is formed by a motor and the like, and adjusts the focal length of the optical system 103 by moving the position of the focus lens as a component of the optical system 103 in an optical axis direction according to a command from the controller 101.

The image capturing section 104 includes the image sensor, such as a CMOS sensor or a charge coupled device (CCD), and converts an optical image of incident light, formed by the optical system 103, to image signals formed by analog electrical signals. Note that in the first embodiment, it is assumed that the image sensor generates one item of image data by one exposure operation. The image capturing section 104 further includes an analog-to-digital convertor that converts the analog electrical signals output from the image sensor to image data formed by digital signals. Although, in FIG. 1, the output (image data) from the image capturing section 104 is sent to the controller 101, the output from the image capturing section 104 can be sent to the image processor 107 and a variety of image processing operations, described hereinafter, can be performed on the image data by the image processor 107.

By driving the image capturing section 104 in a moving image photographing mode, it is possible to capture a plurality of temporally continuous images as frames of a moving image. Further, the image capturing section 104 is capable of measuring an object luminance from a formed optical image. However, the function of measuring an object luminance is not necessarily required to be equipped in the image capturing section 104, but can be realized by separately providing, for example, an AE sensor.

The image processor 107 performs a variety of image processing operations, such as white balance adjustment, color interpolation, filtering, and combination processing, on image data output from the image capturing section 104 or image data stored in the storage 109. Further, the image processor 107 performs compression processing on image data output from the image capturing section 104 based on the JPEG standard, for example.

Note that although as the image processor 107, for example, an application specific integrated circuit (ASIC) formed by circuits for performing specific processing operations is used, the controller 101 can perform part or all of the functions of the image processor 107 by executing a predetermined program. In a case where the controller 101 performs all of the functions of the image processor 107, the image processor 107 as hardware is not required to be equipped.

The display section 108 is formed by, for example, a liquid crystal display or an organic EL display, and displays an image read out from the image capturing section 104 (image processor 107) or the storage 109 and temporarily stored in the RAM 106, a menu screen for performing a variety of settings of the image capturing apparatus 100, and so forth. The storage 109 is a storage device for storing an image captured by the image capturing section 104, an image on which predetermined processing has been performed by the image processor 107, information on an in-focus position at the time of image capturing, and so forth. The storage 109 can be, for example, a memory card which can be attached and removed to and from the image capturing apparatus 100.

In the present embodiment, depths are combined so as to obtain a depth of field according to an object while reducing overexposure part and underexposure part by using a technique for obtaining an image increased in the dynamic range by combining a plurality of images which are different in exposure condition, i.e. a so-called HDR combining technique. The image capturing method involving the depth combination processing and the HDR combination processing is hereinafter referred to as the “depth combination HDR image capturing”. By performing the depth combination HDR image capturing, it is possible to acquire a depth combined image having a depth of field according to an object and an appropriate dynamic range according to a photographing scene.

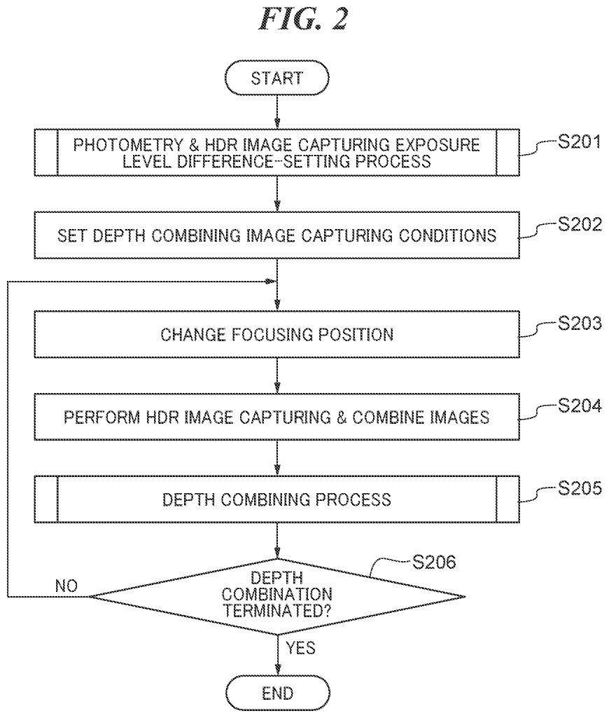

FIG. 2 is a flowchart of an image generation process performed by the image capturing apparatus 100. Each processing (step) denoted by S-number in FIG. 2 is realized by the controller 101 that loads programs stored in the ROM 105 into the RAM 106 to thereby perform centralized control of the operations of the components of the image capturing apparatus 100.

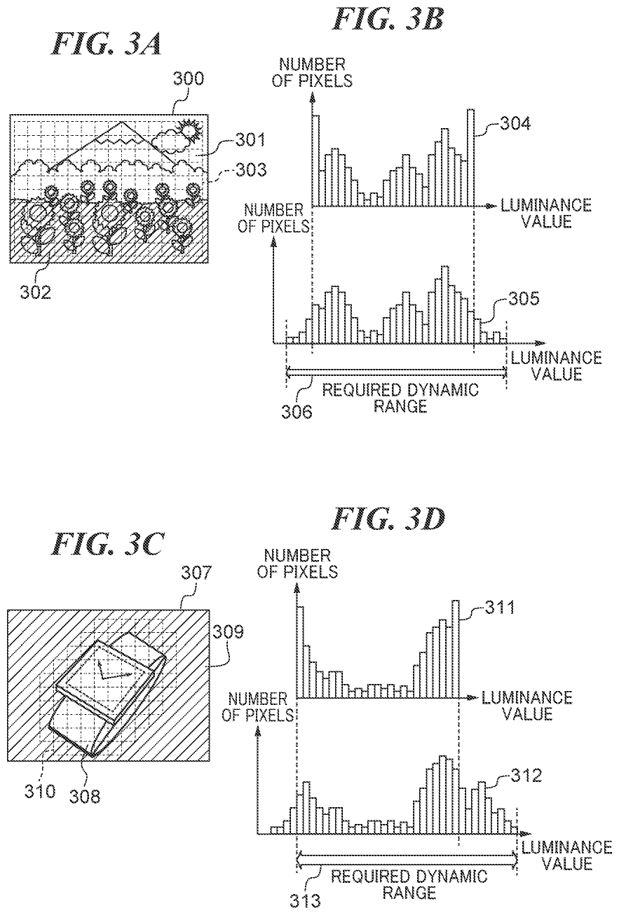

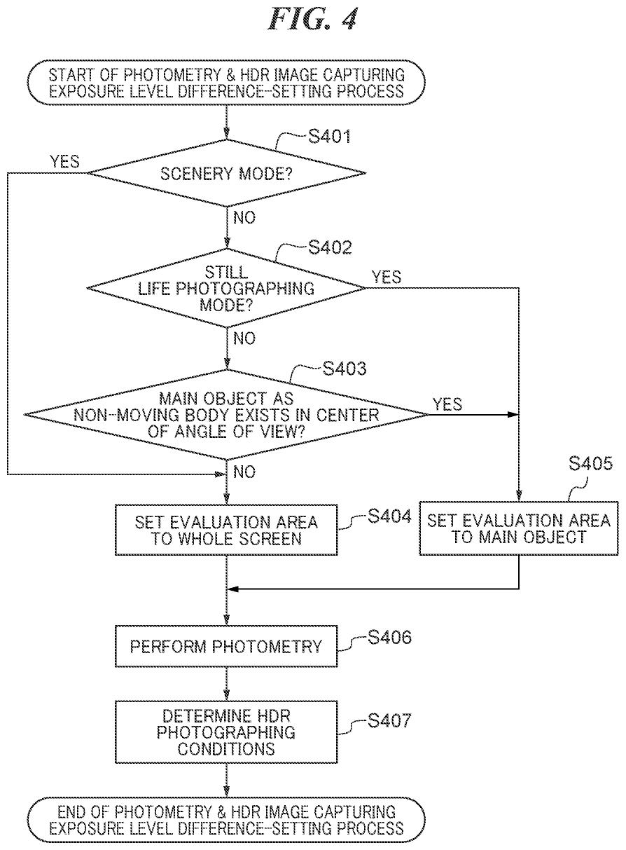

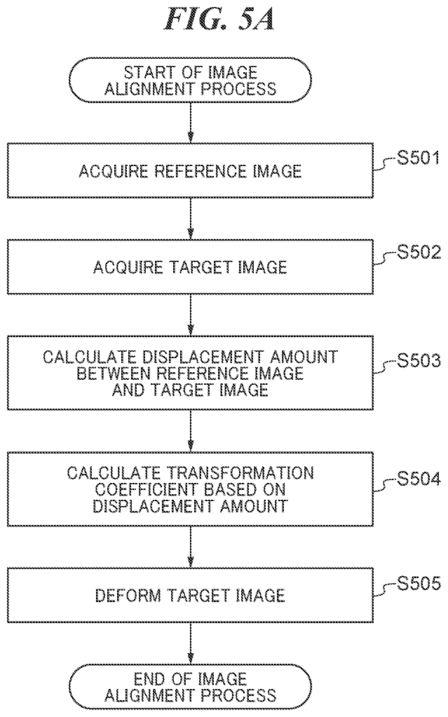

In a step S201, the controller 101 controls the image capturing section 104 to perform photometry on an object and sets exposure level differences applied for HDR image capturing based on luminance information of the object. Here, the step S201 will be described in detail with reference to FIGS. 3A to 3D and 4.

FIGS. 3A to 3D are diagrams useful in explaining two photographing scenes each having a large difference in brightness. FIG. 3A schematically shows a scenery photographing scene having a large difference in brightness, and out of an image capturing range 300, a background 301 is a sunny area, and a foreground 302 is a shadow area. Here, let it be assumed that the image capturing apparatus 100 has been set to a scenery mode as the photographing mode. An evaluation area 303 appearing in FIG. 3A is an area for calculating luminance information of the object and is also used as an area for acquiring depth information. As shown in FIG. 3A, in the scenery mode, the evaluation area 303 is set to substantially the whole of the image capturing range 300, i.e. the area over the background 301 and the foreground 302.

An upper part of FIG. 3B shows a histogram 304 in the photographing scene in FIG. 3A, and it is found that both of overexposure part (right side in which the luminance value is large) and underexposure part (left side in which the luminance value is small) have been generated. A lower part of FIG. 3B shows a histogram 305 in a case where generation of the overexposure part and the underexposure part has been suppressed in the photographing scene in FIG. 3A and shows a dynamic range 306 required for the image capturing range 300.

FIG. 3C schematically shows a still life photographing scene having a large difference in brightness, and out of an image capturing range 307, a main object area 308 is a bright area where light shines, and an area (hatched area) other than the main object area 308 is a background area 309. Here, let it be assumed that the image capturing apparatus 100 has been set to a still life photographing mode as the photographing mode. An evaluation area 310 appearing in FIG. 3C is an area for calculating luminance information of the image and is also used as an area for acquiring depth information. In the scenery photographing scene in FIG. 3A, the evaluation area 303 is set to the image capturing range 300 including the background 301 and the foreground 302. On the other hand, as shown in FIG. 3C, in the still life photographing mode, the evaluation area 310 is set only to an area of a wristwatch as the main object.

An upper part of FIG. 3D shows a histogram 311 in the photographing scene in FIG. 3C, and it is found that both of overexposure part and underexposure part have been generated. A lower part of FIG. 3D shows a histogram 312 in a case where generation of the overexposure part and the underexposure part has been suppressed in the photographing scene in FIG. 3C and shows a dynamic range 313 required for the main object.

FIG. 4 is a flowchart of the photometry and HDR difference-setting process in the step S201 in the depth combined image generation process in FIG. 2. In the description of the photometry and HDR difference-setting process in FIG. 4, FIGS. 3A to 3D are referred to, as required. In a step S401, the controller 101 determines whether or not the photographing mode to which the image capturing apparatus 100 is set is the scenery mode. Note that the user can set the image capturing apparatus 100 to a desired photographing mode by operating a mode dial, not shown, of the operation section 110. The photographing modes other than the scenery mode include a program AE mode, a shutter priority AE mode, an aperture priority AE mode, a scenery mode, a sport mode, a still life photographing mode, and so forth. If it is determined that the image capturing apparatus 100 has been set to a photographing mode other than the scenery mode (No to the step S401), the controller 101 executes a step S402, whereas if it is determined that the image capturing apparatus 100 has been set to the scenery mode (Yes to the step S401), the controller 101 executes a step S404.

In the step S402, the controller 101 determines whether or not the photographing mode to which the image capturing apparatus 100 is set is the still life photographing mode. If it is determined that the image capturing apparatus 100 has been set to the still life photographing mode (Yes to the step S402), the controller 101 executes a step S405, whereas if it is determined that the image capturing apparatus 100 has been set to a photographing mode other than the still life photographing mode (No to the step S402), the controller 101 executes a step S403.

In the step S403, the controller 101 determines whether or not a main object as a non-moving body exists in substantially the center of the angle of view (image capturing range). If it is determined that a main object as a non-moving body does not exist (No to the step S403), the controller 101 executes the step S404, whereas if it is determined that a main object as a non-moving body exists (Yes to the step S403), the controller 101 executes the step S405.

As an example of the determinations in the steps S401 to S403, in a photographing scene in which the image capturing apparatus 100 has been set to a photographing mode other than the still life photographing mode, and a main object does not exist but a plurality of objects exist as shown in the image capturing range 300 in FIG. 3A, the process proceeds to the step S404. On the other hand, in a photographing scene in which the image capturing apparatus 100 has been set to a photographing mode other than the scenery mode, and a main object exists in the center of the angle of view as shown in the image capturing range 307 in FIG. 3C, the process proceeds to the step S405.

In the step S404, the controller 101 sets the evaluation area to the whole image capturing range. For example, as shown in FIG. 3A, the evaluation area 303 is set such that substantially the whole of the image capturing range 300 is covered. Note that in the present embodiment, in a case where the image capturing apparatus 100 has been set to the scenery mode, it is considered that there is a high possibility that it is a photographing scene where a main object does not exist but a plurality of objects exist, so that the determination in the step S403 need not be executed.

In the step S405, the controller 101 sets the evaluation area to the main object. For example, as shown in FIG. 3C, the evaluation area 310 is set to the main object area 308. Note that in the present embodiment, in a case where the still life photographing mode is set, it is considered that there is a high possibility that it is a photographing scene where a main object exists, so that the determination in the step S403 need not be executed.

After the controller 101 sets the evaluation area in the step S404 or S405, the controller 101 executes a step S406. In the step S406, the controller 101 performs photometry on the evaluation area set in the step S404 or S405. In a step S407, the controller 101 determines a HDR image capturing condition. More specifically, in the step S407, the controller 101, first, obtains luminance distribution information (histogram) from the photometry values acquired in the step S406 and determines a luminance range from a difference between the maximum value and the minimum value of the luminance. Then, the controller 101 calculates exposure level differences between underexposure image capturing, proper exposure image capturing, and overexposure image capturing, and the number of times of image capturing, which are necessary for covering the luminance range according to the dynamic range of the image sensor. When the step S407 is terminated, the controller 101 executes a step S202.

The description returns to the depth combined image generation process in FIG. 2. In the step S202, the controller 101 acquires depth information in the evaluation area set in the step S404 or S405 in the step S201. Then, the controller 101 determines the image capturing conditions (depth combining image capturing conditions) for the plurality of images to be captured so as to make each of all objects in the evaluation area focused in at least one of a plurality of images captured by changing the depth of focus based on the acquired depth information. The image capturing conditions of the plurality of images are specifically the number of times of image capturing and a focus shift amount, which are required for depth combination.

In a step S203, the controller 101 controls the drive unit 102 to drive the focus lens by the focus shift amount determined in the step S202 and adjust the focal length of the optical system 103. In a step S204, the controller 101 performs underexposure image capturing, proper exposure image capturing, and overexposure image capturing according to the HDR image capturing conditions determined in the step S407. Further, in the step S204, the controller 101 controls the image processor 107 to perform HDR combination of the obtained underexposure image, proper exposure image, and overexposure image, to thereby generate a HDR combined image.

In a step 205, the controller 101 performs depth combination of the HDR combined images generated in the step S204. Note that in a state in which the process proceeds to the step S205 for the first time, only one HDR combined image has been generated, and hence the step S205 is substantially skipped, further, the answer to a question of a step S206 becomes negative (No), and the process proceeds to the step S203.

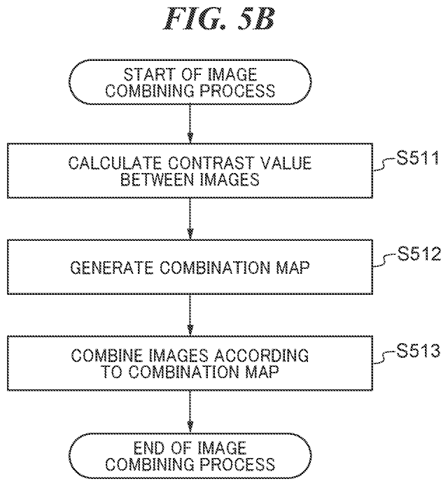

Here, the depth combining process in the step S205 will be described in detail with reference to FIG. 5A and 5B. FIG. 5A is a flowchart of an image alignment process in the depth combining process.

In a step S501, the controller 101 acquires, out of the HDR captured images captured by the image capturing section 104 in the step S204, a reference image to be used in the image alignment process. As the reference image to be used in the image alignment process, for example, an image which is the earliest in an image capturing order can be selected, but the angle of view often slightly changes between the images captured while changing the in-focus position, and hence an image which is the narrowest in the angle of view in the captured images can be selected.

In a step S502, the controller 101 acquires a target image of the image alignment process. The target image of the image alignment process is an image other than the reference image acquired in the step S501, on which the image alignment process has not been performed yet. For example, in a case where an image which is the earliest in the image capturing order is set as the reference image, the controller 101 acquires the target image in the image capturing order.

In a step S503, the controller 101 calculates an amount of displacement between the reference image and the target image. An example of the calculation method will be described below. First, the controller 101 sets a plurality of blocks for the reference image. At this time, it is desirable to set each block to the same size. Next, the controller 101 sets search ranges at the same positions as the respective blocks set for the reference image, each of which is a range wider than an associated one of the blocks of the reference image. Then, the controller 101 calculates a corresponding point in each search range of the target image, at which the sum of absolute differences (SAD) from values of the luminance in a corresponding block of the reference image is the smallest. Further, the controller 101 calculates, based on a positional relationship between the calculated corresponding point and the center of the corresponding block of the reference image, a displacement in position as a vector. Note that calculation of the corresponding point is not limited to a method using the sum of absolute differences (SAD), but there can be also used, for example, a method using the sum of squared differences (SSD) or normalized cross-correlation (NCC).

In a step S504, the controller 101 calculates a transformation coefficient from the vector (the amount of displacement between the reference image and the target image) calculated in the step S503. As the transformation coefficient, a projective transformation coefficient, for example, is used, but this is not limitative, and an affine transformation coefficient or a simplified transformation coefficient including only in horizontal and vertical shifts can be used.

In a step S505, the controller 101 controls the image processor 107 to perform processing for deforming the target image using the transformation coefficient calculated in the step S504. For example, assuming that coordinates after deformation, coordinates before deformation, and the transformation coefficient calculated in the step S505 are represented by P(x′, y′), P(x, y), and a matrix A, respectively, the image processor 107 performs the deformation processing by using the following equation (1), followed by terminating the image alignment process.

$${p}^{′} = [ \begin{matrix}{x}^{′} \\ {y}^{′} \\ 1\end{matrix} ] = AP = [ \begin{matrix}a & b & c \\ d & e & f \\ g & h & i\end{matrix} ] [ \begin{matrix}x \\ y \\ 1\end{matrix} ] \qquad ( 1 )$$

FIG. 5B is a flowchart of an image combining process in the depth combining process. In a step S511, the controller 101 controls the image processor 107 to calculate a contrast value of each image (including the reference image) after the image alignment. The contrast value can be calculated by using the following equations (2) to (5), for example. More specifically, a luminance Y is calculated by the following equation (2) from color signals Sr, Sg, and Sb of each pixel. Then, a Sobel filter is applied to a matrix L of the luminance Y of 3×3 pixels as indicated by the following equations (3) to (5) to calculate a contrast value I. Note that the contrast value calculation method is not limited to this, but for example, the used filter can be replaced by an edge detection filter, such as a Laplacian filter, or a bandpass filter for passing a predetermined frequency band.

$$Y = 0.299 Sr + 0.587 Sg + 0.114 Sb \qquad ( 2 )$$

$${I}_{n} = [ \begin{matrix}- 1 & 0 & 1 \\ - 2 & 0 & 2 \\ - 1 & 0 & 1\end{matrix} ] L \qquad ( 3 )$$

$${I}_{v} = [ \begin{matrix}- 1 & - 1 & - 1 \\ 0 & 0 & 0 \\ 1 & 2 & 1\end{matrix} ] L \qquad ( 4 )$$

$$I = \sqrt{{{I}_{n}}^{2} + {{I}_{v}}^{2}} \qquad ( 5 )$$

In a step S512, the controller 101 controls the image processor 107 to generate a combination map. As the combination map generation method, there can be used a method of comparing the contrast values of pixels in the same position of the respective images and calculating a combination ratio according to the magnitude of each contrast value. For example, out of the pixels in the same positions of the respective images, a combination ratio of 100% is assigned to a pixel having the largest contrast value, and a combination ratio of 0% is assigned to the other pixels. That is, calculation is performed by using the following equation (6):

$${A}_{m} ( x , y ) = \begin{matrix}max \\ k = 1\end{matrix} {C}_{k} ( x , y ) \qquad ( 6 )$$

In the above equation (6), “Ck(x, y)”, “m”, “x”, “y”, and “Am(x, y)” represent the contrast value calculated in the step S511, an m-th image out of the plurality of images which are different in in-focus position, a horizontal coordinate of the image, a vertical coordinate of the image, and a ratio of the combination map, respectively. Note that in the step S512, it is necessary to adjust the combination ratio so as to prevent boundaries from becoming unnatural. For this reason, the combination ratio of the combination map in one image is not set to one of the binary values of 0 (0%) and 1 (100%), but continuously changes.

In a step 513, when the controller 101 controls the image processor 107 to generate a combined image according to the combination map generated in the step S512, followed by terminating the present process. This terminates the depth combining process in the step S205.

The description returns to the flowchart in FIG. 2. In the step S206, the controller 101 determines whether or not the depth combining process is terminated, i.e. whether or not HDR image capturing for depth combination, performed while changing the in-focus position set in the step S202, and depth combination of the HDR images have been terminated. If it is determined that the depth combination process has not been terminated (No to the step S206), the controller 101 returns to the step S203, whereas if it is determined that the depth combination process has been terminated (Yes to the step S206), the controller 101 terminates the present process.

When the depth combination HDR image capturing is performed as described above, the evaluation area for determining the exposure level differences applied for the HDR image capturing is set according to whether or not a main object exists. With this, it is possible to generate an image having a depth of field set according to whether or not a main object exists and having an appropriate dynamic range. In doing this, by automatically setting the evaluation area according to a specific photographing mode, it is possible to start the depth combination HDR image capturing without detecting presence/absence of a main object.

In the above-described embodiment, in a case where the photographing mode to which the image capturing apparatus 100 is set is neither the scenery mode nor the still life photographing mode, the setting form of the evaluation area is determined according to whether or not a main object as a non-moving body exists. In this case, as the method of determining whether or not a main object as a non-moving body exists, there can be used a method of automatic determination using a through image obtained before the HDR image capturing. For example, in a case where the depth of the through image is shallow, the through image is captured in a state in which the depth of field is increased by controlling the drive unit 102 to narrow the aperture of the optical system 103, and it is determined whether the photographing scene is a photographing scene in which a plurality of objects exist in the angle of view or a photographing scene in which a main object exists in the angle of view. Not only this, but preliminary image capturing can be performed before the depth combination HDR image capturing to automatically determine a photographing scene based on an image captured by the preliminary image capturing, or presence/absence of a main object can be automatically determined from the first HDR captured image for the depth combination HDR image capturing. To detect a main object, a known technique, such as pattern matching, can be used.

Further, setting of the evaluation area is not limited to automatic setting performed by the controller 101, but a user (photographer) can set the evaluation area as desired. For example, the controller 101 displays a graphical user interface (GUI) for setting the evaluation area on the display section 108 according to an operation input to the operation section 110 by a user. The GUI can be configured, for example, such that the evaluation area is drawn by a touch operation, or the size and the shape of a polygon, such as a quadrangle, are changed.

In the first embodiment, the image sensor included in the image capturing section 104 is configured to generate one image data by one exposure operation. In contrast, in a second embodiment, the image sensor included in the image capturing section 104 is a so-called Dual Gain Output (DGO) device. The DGO device has two column circuits for an output signal from a unit pixel and a gain of an amplifier in each column circuit is separately provided, whereby the DGO device can output two images (High gain and Low gain images) different in gain by one exposure operation. In a case where the depth combination HDR image capturing is performed by using the DGO device, since two images are obtained by one exposure operation, image alignment between these images is not required for HDR combination, and in a case where objects include a moving body, it is possible to suppress a blur (unclearness) of the moving body.

In a case where the DGO device is used in the present disclosure, in the step S202 of the flowchart in FIG. 2, the controller 101 performs DGO image capturing for acquiring an underexposure image (Low gain image) and a proper exposure image (High gain image) according to the image capturing conditions determined in the step S407 of the flowchart in FIG. 4. Then, the controller 101 controls the image processor 107 to perform HDR combination using the plurality of obtained images in the step S204. Thus, by using the DGO captured images for HDR combination, it is possible to generate a depth combined image which is appropriately increased in the dynamic range while suppressing occurrence of a blur in a moving body. Note that the other processing operations are equivalent to those in the first embodiment, and hence description thereof is omitted.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-181827 filed Nov. 14, 2022, which is hereby incorporated by reference herein in its entirety.

What is claimed is:

1. An image capturing apparatus comprising:
an image capturing unit configured to capture an image of an object;
at least one processor; and
a memory coupled to the at least one processor, the memory having instructions that, when executed by the processor, perform the operations as:
a setting unit configured to set an evaluation area for determining exposure level differences applied when HDR image capturing is performed by the image capturing unit;
an acquisition unit configured to acquire depth information in the evaluation area;
a determination unit configured to determine image capturing conditions so as to make each of all objects in the evaluation area focused in at least one of a plurality of images captured by changing a depth of focus based on the depth information;
a control unit configured to control the image capturing unit to perform the HDR image capturing according to the image capturing conditions;
a combination unit configured to generate a plurality of HDR images by combining images each obtained by the HDR image capturing performed according to each image capturing condition; and
a generation unit configured to generate a depth combined image from the plurality of HDR images generated by the combination unit.

2. The image capturing apparatus according to claim 1, wherein the at least one memory and the at least one processor further function as a unit configured to set a photographing mode,
wherein in a case where the photographing mode is set to a scenery mode, the setting unit sets the evaluation area to substantially the whole image capturing range to be captured by the image capturing unit.

3. The image capturing apparatus according to claim 2, wherein in a case where the photographing mode is set to a still life photographing mode, the setting unit sets the evaluation area to a main object included in an image capturing range to be captured by the image capturing unit.

4. The image capturing apparatus according to claim 1, wherein the at least one memory and the at least one processor further function as a determination unit configured to determine whether or not a main object as a non-moving body exists in substantially a center of an image capturing range to be captured by the image capturing unit, and
wherein the setting unit sets the evaluation area to substantially the whole image capturing range to be captured by the image capturing unit, in a case where it is determined that the main object does not exist, and sets the evaluation area to the main object in a case where it is determined that the main object exists.

5. The image capturing apparatus according to claim 4, wherein the determination unit performs the determination based on a through image obtained by the image capturing unit.

6. The image capturing apparatus according to claim 4, wherein the control unit controls the image capturing unit to perform preliminary image capturing before performing the HDR image capturing, and
wherein the determination unit performs the determination using an image obtained by the preliminary image capturing.

7. The image capturing apparatus according to claim 4, wherein the control unit performs the determination using a first image obtained by the HDR image capturing.

8. The image capturing apparatus according to claim 1, wherein the setting unit is an operation unit configured to set the evaluation area according to an input operation.

9. The image capturing apparatus according to claim 1, wherein the determination unit determines the exposure level differences based on luminance information of an object included in the evaluation area.

10. The image capturing apparatus according to claim 1, wherein the image capturing conditions include the number of times of image capturing and a focus shift amount.

11. The image capturing apparatus according to claim 1, wherein the image capturing unit includes an image sensor that outputs a plurality of images to which different gains are applied, by one exposure operation, and
wherein the determination unit determines the exposure level differences according to the different gains.

12. A method of controlling an image capturing apparatus, comprising:
setting an evaluation area for determining exposure level differences applied when HDR image capturing is performed by an image capturing unit;
acquiring depth information in the evaluation area;
determining image capturing conditions so as to make each of all objects in the evaluation area focused in at least one of a plurality of images captured by changing a depth of focus based on the depth information;
controlling the image capturing unit to perform the HDR image capturing according to the image capturing conditions;
generating a plurality of HDR images by combining images each obtained by the HDR image capturing performed according to each image capturing condition; and
generating a depth combined image from the plurality of generated HDR images.

13. A non-transitory computer-readable storage medium storing a program for causing a computer to execute a method of controlling an image capturing apparatus,
wherein the method comprises:
setting an evaluation area for determining exposure level differences applied when HDR image capturing is performed by an image capturing unit;
acquiring depth information in the evaluation area;
determining image capturing conditions so as to make each of all objects in the evaluation area focused in at least one of a plurality of images captured by changing a depth of focus based on the depth information;
controlling the image capturing unit to perform the HDR image capturing according to the image capturing conditions;
generating a plurality of HDR images by combining images each obtained by the HDR image capturing performed according to each image capturing condition; and
generating a depth combined image from the plurality of generated HDR images.
